(19) United States
(12) Patent Application Publication
(10) Pub. No.: US 2015/0181634 A1
(43) Pub. Date: Jun. 25, 2015

(54) PAIRING METHOD FOR MOBILE DEVICE AND PAIRING SYSTEM FOR MOBILE DEVICE

(71) Applicants: Qisda (Suzhou) Co., Ltd., Suzhou (CN); Qisda Corporation, Taoyuan (TW)

(72) Inventor: CHIH-TAI CHENG, New Taipei City (TW)

(21) Appl. No.: 14/578,524

(22) Filed: Dec. 22, 2014

(30) Foreign Application Priority Data
Dec. 23, 2013 (TW) 102147800

(51) Int. Cl. H04W 76/02; H04W 4/02; H04M 1/725; H04W 4/00

(52) U.S. Cl. CPC H04W 76/023; H04W 4/008; H04W 4/026; H04W 4/027; H04M 1/72569

(57) ABSTRACT

A pairing method for mobile device includes steps of: establishing a wireless communication link between a first mobile device and a second mobile device; configuring the second mobile device to send a second data relating to a second movement of the second mobile device in a specific period; configuring the first mobile device to receive the second data from the second mobile device and determining whether or not the second data is matched with a first data relating to a first movement of the first mobile device in the specific period ; and pairing the first mobile device with the second mobile device if the first data is matched with the second data. A corresponding pairing system for mobile device is also provided.

### FIELD OF THE INVENTION

The present invention relates to a pairing method and a pairing system, and more particularly to a pairing method and a pairing system used for two neighboring mobile devices with wireless communication function.

### BACKGROUND OF THE INVENTION

Through a short-range wireless communications technology, such as Bluetooth and WiFi, multiple mobile devices can wirelessly communicate with each other within a certain range. Basically, all of the multiple mobile devices within a certain range can receive signals from one another based on the above mentioned short-range wireless communication technologies. However, if any two of the multi mobile devices require a highly-demanded (or higher level of) security therebetween, the two mobile devices may need to be paired with each other first. Conventionally, the pairing is realized by a verification code input procedure, and the input of the verification code may be manually performed by a user or automatically performed by the mobile device. However, once the user forgets the verification code or when the mobile device loses the verification code, the two mobile devices then may not be paired successfully.

### SUMMARY OF THE INVENTION

Therefore, one object of the present invention is to provide a pairing method and a pairing system able to pairing two mobile devices based on the movements thereof instead of inputting the validation code. Thus, through the intuitive pairing method and system provided by the present invention, the conventional fail pairing caused by wrong/missing validation code is avoided.

The present invention provides a pairing method for mobile device, which includes steps of: establishing a wireless communication link between a first mobile device and a second mobile device; configuring the second mobile device to send a second data relating to a second movement of the second mobile device in a specific period; configuring the first mobile device to receive the second data from the second mobile device and determining whether or not the second data is matched with a first data relating to a first movement of the first mobile device in the specific period; and pairing the first mobile device with the second mobile device if the first data is matched with the second data.

The present invention further provides a pairing system for mobile device, which includes a first mobile device and a second mobile device. The first mobile device includes a first processor, a first wireless communication module and a first movement sensing module. The first processor is electrically connected with the first wireless communication module and the first movement sensing module. The first movement sensing module senses a first movement of the first mobile device in a specific period and accordingly generates a first data relating to the first movement. The second mobile device includes a second processor, a second wireless communication module and a second movement sensing module. The second processor is electrically connected with the second wireless communication module and the second movement sensing module. The second movement sensing module senses a second movement of the second mobile device in the specific period and accordingly generates a second data relating to the second movement. The first mobile device and the second mobile device establish a wireless communication link therebetween through the first wireless communication module and the second wireless communicate module. The second processor sends the second data through the second wireless communication module. The first processor receives the second data through the first wireless communication module and determines whether the first data is matched with the second data. The first mobile device is paired with the second mobile device if the first data is matched with the second data.

In summary, the present invention discloses pairing method and pairing system for mobile device, in which the two mobile devices will pair with each other if the movements of them are matched.

For making the above and other purposes, features and benefits become more readily apparent to those ordinarily skilled in the art, the preferred embodiments and the detailed descriptions with accompanying drawings will be put forward in the following descriptions.

### BRIEF DESCRIPTION OF THE DRAWINGS

The present invention will become more readily apparent to those ordinarily skilled in the art after reviewing the following detailed description and accompanying drawings, in which:

FIG. 1 is a schematic view of a mobile device pairing system in accordance with an embodiment of the present invention;

FIG. 2 is a flowchart illustrating a mobile device pairing method in accordance with an embodiment of the present invention;

FIG. 3 is a functional block view of the first mobile device and the second mobile device shown in FIG. 1 in accordance with an embodiment of the present invention;

FIG. 4 is a flowchart illustrating the process of the first mobile device shown in FIG. 3 performing the mobile device pairing method in accordance with an embodiment of the present invention;

FIG. 5 is a flowchart illustrating the process of the second mobile device shown in FIG. 3 performing the mobile device pairing method in accordance with an embodiment of the present invention; and

FIG. 6 is a schematic view illustrating the first mobile device and the second mobile device shown in FIG. 3 being stacked up.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

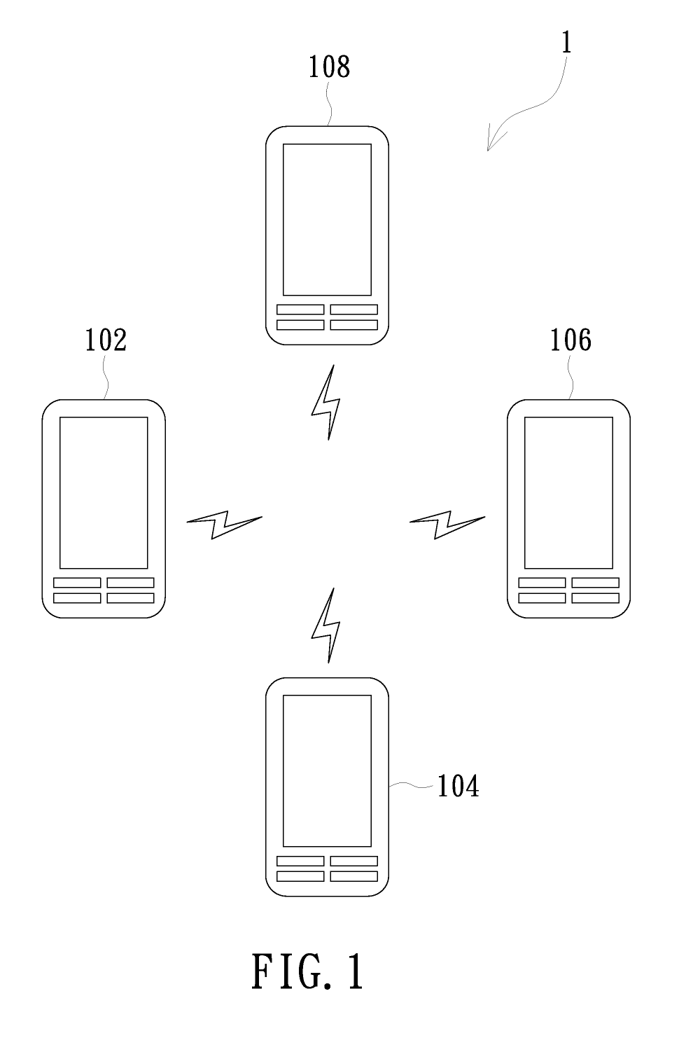

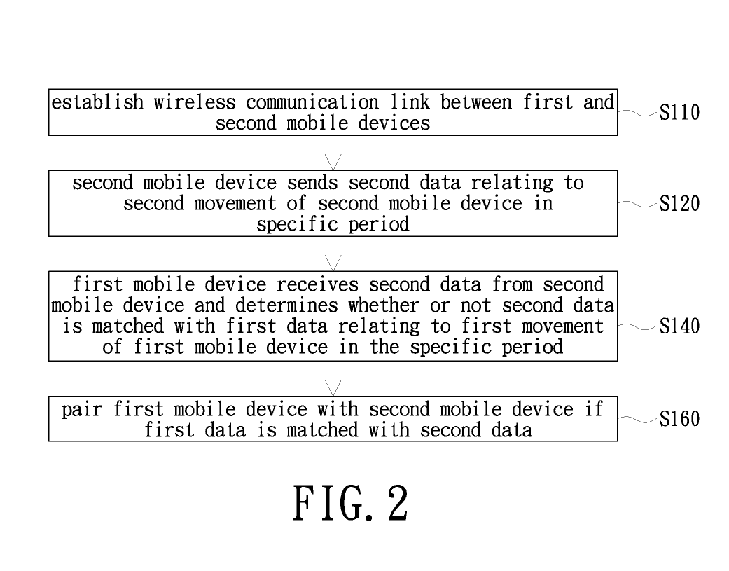

FIG. 1 is a schematic view of a mobile device pairing system in accordance with an embodiment of the present invention. As shown, the mobile device pairing system 1 in the present embodiment includes a plurality of mobile devices 102, 104, 106 and 108. The mobile devices 102, 104, 106 and 108 are in communication with one another based on a short-range wireless communication technology, such as but not limited to, Bluetooth or WiFi; and the mobile devices 102, 104, 106 and 108 are located in an area with a certain valid or effective communication range of the short-range wireless communication technology. When any two of the mobile devices 102, 104, 106 and 108 (for example, the mobile devices 102, 104) are required to be paired with each other for, such as but not limited to, a communication with highly-demanded (or higher level of) security, the mobile device pairing system 1 can use a mobile device pairing method, that is disclosed by an embodiment of the present invention and will be described as follow in FIG. 2, to pair the mobile devices 102, 104.

FIG. 2 is a flowchart illustrating a mobile device pairing method in accordance with an embodiment of the present invention. As shown, firstly, a wireless communication link is established between a first mobile device and a second mobile device (step S100). Next, the second mobile device sends a second data relating to a second movement of the second mobile device in a specific period to the first mobile device (step S120). Next, the first mobile device receives the second data from the second mobile device and determines whether or not the second data is matched with a first data relating to a first movement of the first mobile device in the specific period (step S140). Next, the first mobile device and the second mobile device are paired with each other if the first mobile device determines that the first data is matched with the second data (step S160).

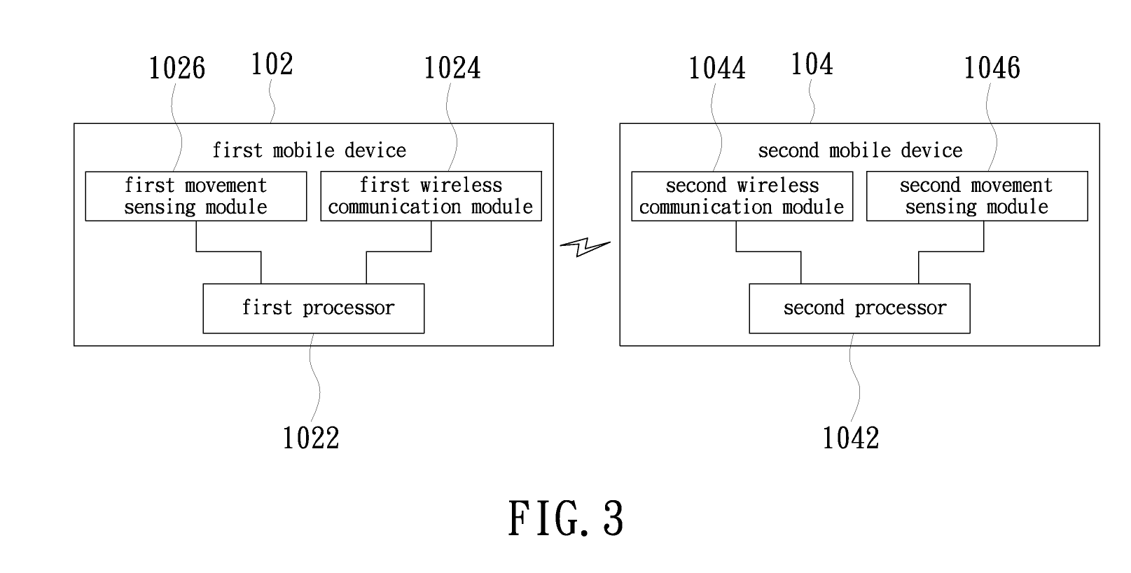

The process of the mobile device pairing method for the mobile devices 102, 104 will be described in detail as follow. To facilitate a better understanding of the present invention, the mobile device 102 hereafter is referred to a first mobile device 102 and the mobile device 104 hereafter is referred to a second mobile device 104. Please refer to FIG. 3, which shows a functional block diagram of the first mobile device 102 and the second mobile device 104 in accordance with an embodiment of the present invention. As shown, the first mobile device 102 in the present embodiment includes a first processor 1022, a first wireless communication module 1024 and a first movement sensing module 1026. The first processor 1022 is electrically connected with the first wireless communication module 1024 and the first movement sensing module 1026, respectively. Specifically, the first mobile device 102 is configured to have a wireless communication with other devices through the first wireless communication module 1024, sense the movement of itself through the first movement sensing module 1026, and process relating data through the first processor 1022. Likewise, the second mobile device 104 in the present embodiment includes a second processor 1042, a second wireless communication module 1044 and a second movement sensing module 1046. The second processor 1042 is electrically connected with the second wireless communication module 1044 and the second movement sensing module 1046, respectively. Specifically, the second mobile device 104 is configured to have a wireless communication with other devices through the second wireless communication module 1044, sense the movement of itself through the second movement sensing module 1046, and process relating data through the second processor 1042.

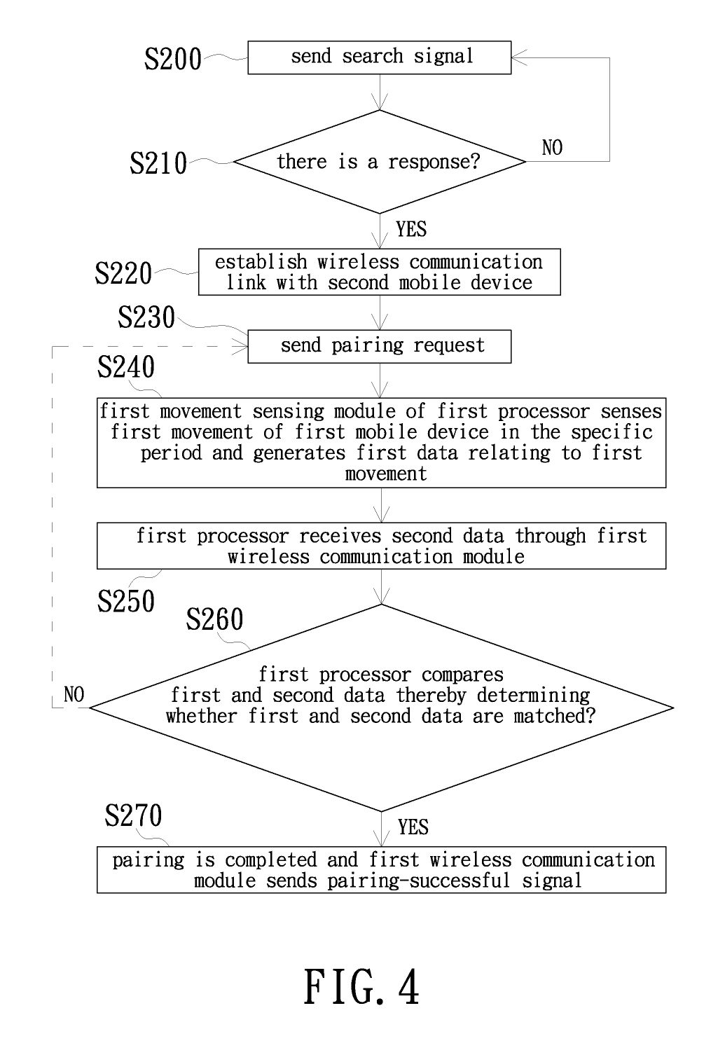

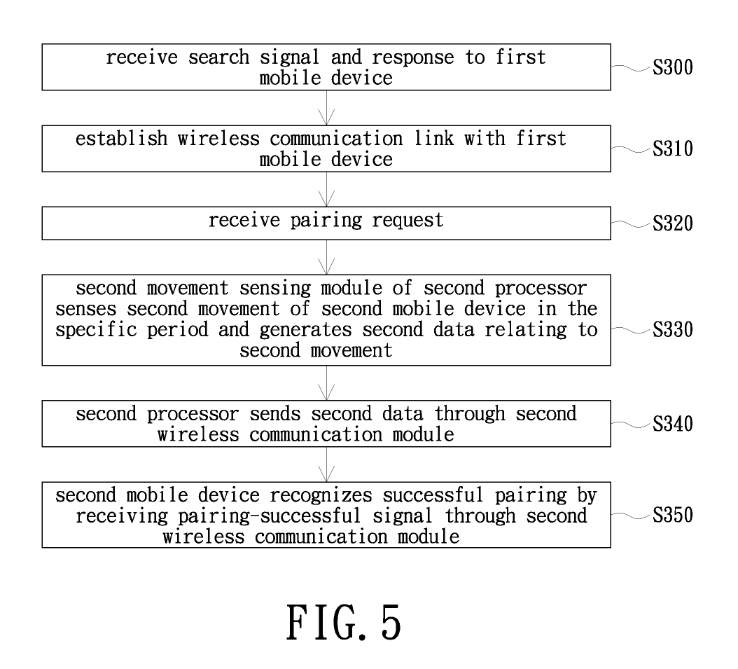

FIG. 4 is a flowchart illustrating the process of the first mobile device 102 performing the above mentioned mobile device pairing method in accordance with an embodiment of the present invention. FIG. 5 is a flowchart illustrating the process of the second mobile device 104 performing the above mentioned mobile device pairing method in accordance with an embodiment of the present invention. Please refer to FIGS. 3-5 together. As shown, firstly, the first mobile device 102 sends a search signal (step S200). Next, the first mobile device 102 confirms as to whether there is a response relating to the search signal (step S210). Because being neighboring (and at relative close proximity) to the first mobile device 102, the second mobile device 104 can receive the search signal and make a response, such as sending a response signal, to the first mobile device 102 (step S300). Next, the the first mobile device 102 receives the response signal from the second mobile device 104 and establishes a wireless communication link between the first mobile device 102 and the second mobile device 104 (steps S220, S310). Specifically, the first mobile device 102 and the second mobile device 104 establish the wireless communication connection formed therebetween through the first wireless communication module 1024 and the second wireless communication module 1044, respectively.

Next, the first mobile device 102 sends a pairing request to the second mobile device 104 (step S230); and correspondingly, the second mobile device 104 receives the pairing request (step S320). Specifically, because the pairing in the present invention is realized based on comparing the movements of two mobile devices in a specific period, it is understood that the pairing request contains the information about the specific period; thus, the first mobile device 102 and the second mobile device 104 can sense and record the movements thereof in the same specific period at the same time. Next, the first mobile device 102 controls, through the first processor 1022, the first movement sensing module 1026 to sense a first movement of the first mobile device 102 in the specific period and accordingly generates the first data relating to the first movement (step S240). Similarly, the second mobile device 104 controls, through the second processor 1042, the second movement sensing module 1046 to sense a second movement of the second mobile device 104 in the specific period and accordingly generates the second data relating to the second movement (step S330). In one embodiment, the send-out of the above pairing request may be manually activated by a user or automatically activated by an application installed in the first mobile device 102.

Next, by using the second processor 1042, the second mobile device 104 sends the second data through the second wireless communication module 1044 (step S340). Next, by using the first processor 1022, the first mobile device 102 receives the second data through the first wireless communication module 1024 (step S250). Next, the first processor 1022 in the first mobile device 102 compares the first data with the second data thereby determining whether the first and second data are matched with each or not (step S260). The pairing is completed if the determination result in step S260 is positive which indicates that the first data is matched with the second data, and accordingly the first mobile device 102 sends a pairing-successful signal through the first wireless communication module 1024 (step S270). It is to be noted that the second mobile device 104 waits for the pairing result once the second data is sent out. Next, the second mobile device 104 recognizes a successful pairing with the first mobile device 102 in response to a receiving of the pairing-successful signal through the second wireless communication module 1044 (step S350). Alternatively, the first mobile device 102 may resend a new pairing request (step S230) if the determination result in step S260 is negative which indicates that the first data is not matched with the and second data (the processing path indicated by dot lines going from step S260 to step S230), and accordingly the mobile device pairing method in the present embodiment moves back to step S230. In another embodiment, the first mobile device 102 may directly send a pairing-fail signal to the second mobile device 104 if the determination result in step S260 is negative. It is to be noted that a slight tolerance between the first and second data is acceptable. For example, the above determination result still is positive if the track error between the first movement of the first mobile device 102 and the second movement of the second mobile device 104 is, for example, less than 1 cm. In one embodiment, the second data simply is a plurality of sensing data generated by the second movement sensing module 1046 and the second mobile device 104 may directly send the second data to the first mobile device 102 without analyzing in advance. Correspondingly, the first mobile device 102 analyzes the second data if necessary and compares the (analyzed) second data with the first data.

Because most of the current smart phones are equipped with gyroscopes, acceleration sensors or earth inductors, the sense of the movements of the first mobile device 102 and the second mobile device 104 may be realized by the above devices. In one embodiment, for example, the first movement sensing module 1026 of the first mobile device 102 may include a first gyroscope or a first earth inductor and the second movement sensing module 1046 of the second mobile device 104 may include a second gyroscope or a second earth inductor. Correspondingly, in step S240, the first gyroscope or the first earth inductor senses a first orientation (direction and/or position) of the first mobile device 102 in the specific period; accordingly, it is understood that the first data contains the information about the first orientation. Likewise, in step S330, the second gyroscope or the second earth inductor senses a second orientation (direction and/or position) of the second mobile device 104 in the specific period; accordingly, it is understood that the second data contains the information about the second orientation.

In another embodiment, the first movement sensing module 1026 of the first mobile device 102 may include a first acceleration sensor and the second movement sensing module 1046 of the second mobile device 104 may include a second acceleration sensor. Correspondingly, in step S240, the first acceleration sensor senses a first acceleration of the first mobile device 102 in the specific period; accordingly, it is understood that the first data contains the information about the first acceleration. Likewise, in step S330, the second acceleration sensor senses a second acceleration of the second mobile device 104 in the specific period; accordingly, it is understood that the second data contains the information about the second acceleration. To simply the following data comparison, it is preferred that the first and second movement sensing modules 1026, 1046 are the same type of sensor (for example, the gyroscope, acceleration sensor or earth inductor); however, the present invention is not limited thereto.

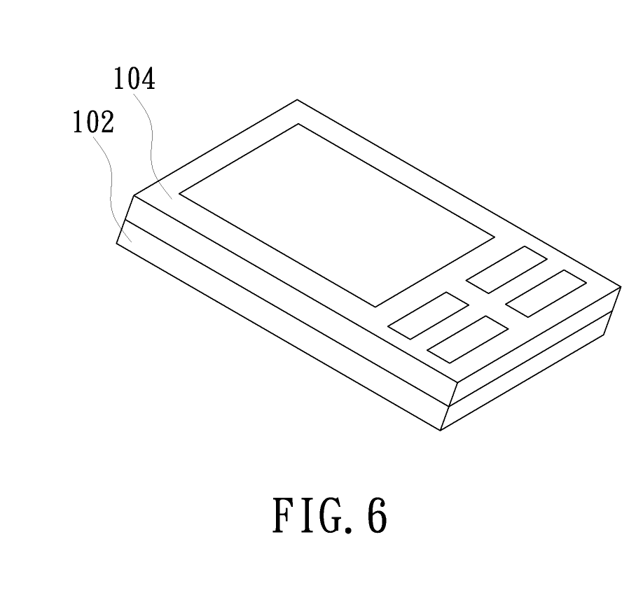

Basically, the orientations or the values of the acceleration sensed in the specific period vary with time. Thus, in one embodiment, these sensing values varying with time may be integrated and analyzed to generate a track of the respective mobile device. In other words, the first data indicates a track of the first movement of the first mobile device and the second data indicates a track of the second movement of the second mobile device. In one embodiment, before sensing the movements of the first and second mobile devices 102, 104 (steps S240, S330 in FIGS. 4, 5), the first and second mobile devices 102, 104 are stacked up (as illustrated in FIG. 6) and then move together. As a result, the difference between the first data and the second data is greatly reduced. In addition, it is to be noted that the data relating to the movement is not necessary to be a complete track; in other words, the data relating to the movement may simply represent the changes of the orientation or the acceleration.

As illustrated in FIG. 1, the mobile devices 102, 104 are exemplified as mobile phones; however the present invention is not limited thereto. The mobile device of the present invention may be any device with wireless communication functions, such as personal digital assistants (PDA) or tablet computers. In addition, to facilitate a better understanding of the present invention, the first mobile device 102 and the second mobile device 104 are exemplarily functioned as a master device and a slave device, respectively; however the present invention is not limited thereto. In other words, the roles of master or slave mobile device may be decided based on which mobile device initials the pairing request. For example, the second mobile device 104 is functioned as a master device if the second mobile device 104 is controlled to send the pairing request first.

In summary, through comparing the movements of two mobile devices thereby determining whether the movements are matched with each other or not, the pairing method and pairing system for mobile device disclosed in the present invention can, when the movements are matched with each other, pair the two mobile devices instead of inputting the validation code in prior art. Thus, through the intuitive pairing method and system provided by the present invention, a conventional fail pairing of mobile devices caused by wrong/missing validation code is avoided.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A pairing method for mobile device, comprising steps of:
(a) establishing a wireless communication link between a first mobile device and a second mobile device;
(b) configuring the second mobile device to send a second data relating to a second movement of the second mobile device in a specific period;
(c) configuring the first mobile device to receive the second data from the second mobile device and determining whether or not the second data is matched with a first data relating to a first movement of the first mobile device in the specific period; and
(d) pairing the first mobile device with the second mobile device if the first data is matched with the second data.

2. The pairing method for mobile device according to claim 1, wherein the second mobile device comprises a second gyroscope or a second earth inductor and correspondingly the step (b) comprises a sub-step of:
configuring the second mobile device to sense a second orientation in the specific period by the second gyroscope or the second earth inductor,
wherein the second data comprises an information relating to the second orientation.

3. The pairing method for mobile device according to claim 2, wherein the first mobile device comprises a first gyroscope or a first earth inductor and correspondingly the step (c) comprises a sub-step of:
configuring the first mobile device to sense a first orientation in the specific period by the first gyroscope or the first earth inductor,
wherein the first data comprises an information relating to the first orientation.

4. The pairing method for mobile device according to claim 1, wherein the second mobile device comprises a second acceleration sensor and correspondingly the step (b) comprises a sub-step of:
configuring the second mobile device to sense a second acceleration in the specific period by the second acceleration sensor,
wherein the second data comprises an information relating to the second acceleration.

5. The pairing method for mobile device according to claim 4, wherein the first mobile device comprises a first acceleration sensor and correspondingly the step (c) comprises a sub-step of:
configuring the first mobile device to sense a first acceleration in the specific period by the first acceleration sensor,
wherein the first data comprises an information relating to the first acceleration.

6. The pairing method for mobile device according to claim 1, wherein the second data is a track of the second movement.

7. The pairing method for mobile device according to claim 1, wherein the second data is a plurality of sensing data of the second movement.

8. The pairing method for mobile device according to claim 1, wherein before the step (b), the pairing method for mobile device further comprises steps of:
stacking the first mobile device and the second mobile device; and
moving the first mobile device and the second mobile device together in the specific period.

9. The pairing method for mobile device according to claim 1, wherein before the step (a), the pairing method for mobile device further comprises steps of:
configuring the first mobile device to send a search signal; and
configuring the second mobile device to receive the search signal and respond to the first mobile device.

10. A pairing system for mobile device, comprising:
a first mobile device, comprising:
a first processor;
a first wireless communication module electrically connected with the first processor; and
a first movement sensing module electrically connected with the first processor, sensing a first movement of the first mobile device in a specific period and generating a first data relating to the first movement; and
a second mobile device, comprising:
a second processor;
a second wireless communication module electrically connected with the first processor and forming a wireless communication link to the first wireless communication module; and
a second movement sensing module electrically connected with the first processor, sensing a second movement of the second mobile device in the specific period, and generating a second data relating to the second movement,
wherein the second processor sends the second data through the second wireless communication module, and the first processor receives the second data through the first wireless communication module and determines whether the first data is matched with the second data,
wherein the first mobile device is paired with the second mobile device if the first data is matched with the second data.

11. The pairing system for mobile device according to claim 10, wherein the second movement sensing module comprises a second gyroscope or a second earth inductor for sensing a second orientation of the second mobile device in the specific period, and the second data includes an information relating to the second orientation.

12. The pairing system for mobile device according to claim 11, wherein the first movement sensing module comprises a first gyroscope or a first earth inductor for sensing a first orientation of the first mobile device in the specific period, and the first data includes an information relating to the first orientation.

13. The pairing system for mobile device according to claim 10, wherein the second movement sensing module comprises a second acceleration sensor for sensing a second acceleration of the second mobile device in the specific period, and the second data includes an information relating to the second acceleration.

14. The pairing system for mobile device according to claim 13, wherein the first movement sensing module comprises a first acceleration sensor for sensing a first acceleration of the first mobile device in the specific period, and the first data includes an information relating to the first acceleration.

15. The pairing system for mobile device according to claim 10, wherein the second data is a track of the second movement.

16. The pairing system for mobile device according to claim 10, wherein the second data is a plurality of sensing data of the second movement.

17. The pairing system for mobile device according to claim 10, wherein the first mobile device and the second mobile device are stacked up and move together in the specific period.

18. The pairing system for mobile device according to claim 10, wherein the first mobile device sends a search signal through the first wireless communication module, and the second mobile device receives the search signal and responds to the first mobile device through the second wireless communication module.
